(19) United States
(12) Patent Application Publication
(10) Pub. No.: US 2011/0237251 A1
(43) Pub. Date: Sep. 29, 2011

(54) IDLE AND PAGING SUPPORT FOR WIRELESS COMMUNICATION SYSTEMS WITH PRIVATE CELLS

(75) Inventors: Jerry Pak Lup Chow, San Diego, CA (US); Tricci So, San Diego, CA (US)

(73) Assignee: ZTE (USA) INC., Iselin, NJ (US)

(21) Appl. No.: 13/054,484

(22) PCT Filed: Jul. 14, 2009
(86) PCT No.: PCT/US09/50608

§ 371 Date: Jun. 14, 2011

Related U.S. Application Data
(60) Provisional application No. 61/080,659, filed on Jul. 14, 2008.
(60) Provisional application No. 61/158,723, filed on Mar. 9, 2009.

(51) Int. Cl. H04W 68/00; H04W 4/00

(52) U.S. Cl. 455/434; 455/456.1; 455/458

(57) ABSTRACT

Systems, apparatuses, and techniques for operating a wireless communication system with public and private paging groups. Systems, apparatuses, and techniques can include operating a base station to provide wireless service to mobile stations in a macrocell, the macrocell associated with a public paging group identifier and a private paging group identifier; assigning the private paging group identifier to one or more private cells that are spatially situated in at least a portion of the macrocell, the one or more private cells are operable by one or more base stations to restrict wireless access to specific wireless devices; and using wireless device access privileges associated with the one or more private cells for one or more wireless operations associated with the mobile stations, the wireless operations including paging and location update.

### CROSS REFERENCE TO RELATED APPLICATIONS

This document claims the benefit of the priority of U.S. Provisional Application Ser. No. 61/080,659, filed Jul. 14, 2008 and entitled “Efficient Method of Idle/Paging Support In Wireless Networks Containing Private Cells,” the entire contents of which are hereby incorporated by reference. This document additionally claims the benefit of the priority of U.S. Provisional Application Ser. No. 61/158,723, filed Mar. 9, 2009 and entitled “Efficient Method of Idle/Paging Support In Wireless Networks Containing Private Cells,” the entire contents of which are hereby incorporated by reference.

### BACKGROUND

This document relates to wireless communication systems, apparatus and techniques.

Wireless communication systems use electromagnetic waves to communicate with fixed and mobile wireless communication devices, e.g., mobile wireless phones and laptop computers with wireless communication cards, that are located within cells of coverage areas of the systems. A wireless communication systems can be referred to as a wireless network Base stations are spatially distributed to provide radio coverage in a geographic service area that is divided into radio cells. In operation, a base station transmits information to a wireless subscriber station such as a mobile station via BS-generated downlink radio signals. A mobile station at a particular cell transmits information to its serving base station for that particular cell via uplink radio signals. The base stations can include directional antennas to further divide each cell into different cell sectors where each antenna covers one sector. This sectorization of a cell increases the communication capacity.

Wireless communication systems can include a network of one or more base stations to communicate with one or more wireless devices such as a mobile device, cell phone, wireless air card, mobile station (MS), user equipment (UE), access terminal (AT), or subscriber station (SS). Base station (BS) can emit radio signals that carry data such as voice data and other data content to wireless devices. In various wireless communication systems, wireless coverage can be divided into many geographic areas, called cells. A base station can provide wireless service in one or more cells to one or more wireless devices. Various examples of cells include macrocell, microcell, and picocell, which can differ in size and capacity.

A femtocell is a smaller scale cell that can provide wireless service to homes, businesses, and areas which may not be adequately covered by a macro cell or a different cell in a wireless communication system. A base station that provides wireless service for one or more femtocells can be referred to as a Femto Access Point (FAP). A FAP can connect to a wireless operator's core network equipment via a backhaul connection. A FAP can use wired or wireless broadband connection at home or business, e.g., ADSL, cable modem, fiber, wireless microwave, wireless interoperability for microwave access (WiMAX) technologies, as a backhaul connection. When a wireless device enters a femto cell coverage area, the wireless device can communicate with the associated FAP over a wireless air interface technology and can receive services from the same wireless operator via the broadband backhaul connection of the FAP.

A base station and a wireless device can wirelessly communicate using one or more wireless air interface technologies such as those defined in 3GPP2, 3GPP, and IEEE 802.16 specifications. Various examples of air interface technologies include Code Division Multiple Access (CDMA), CDMA2000, High Rate Packet Data (HRPD), Universal Mobile Telecommunications System (UMTS), and WiMAX.

### SUMMARY

This document describes technologies, among other things, for operating a wireless communication system associated with one or more private cells.

In one aspect, techniques for wireless communication can include operating a base station to provide wireless service to mobile stations in a macrocell, the macrocell associated with a public paging group identifier and a private paging group identifier; assigning the private paging group identifier to one or more private cells that are spatially situated in at least a portion of the macrocell, the one or more private cells are operable by one or more base stations to restrict wireless access to specific wireless devices; and using wireless device access privileges associated with the one or more private cells for one or more wireless operations associated with the mobile stations, the wireless operations including paging and location update. Other implementations can include corresponding systems, apparatus, and computer programs, configured to perform the actions of the techniques, encoded on computer readable mediums.

These and other implementations can include one or more of the following features. Features can include accessing information associated the one or more private cells, the information indicative of a private cell access privilege of a wireless device. Accessing information associated the one or more private cells can include accessing a private cell identifier associated with the private cell access privilege and paging group identifier associated with the private cell identifier. Assigning the private paging group identifier to one or more private cells can include assigning a single paging group identifier to multiple private cells based on a geographic proximity of the multiple private cells by an overlap of each of the multiple private cells coverage areas within a coverage area the macrocell or a set of adjacent macrocells.

These and other implementations can include using a pre-allocated group of paging group identifiers to assign a private paging group to multiple private cells and one or more associated overlying macrocells; and using a pre-allocated group of paging group identifiers to assign a public paging group to a wireless cell operable for public wireless access.

These and other implementations can include assigning a femtocell associated with a femto base station to a closed service group and to an open user group. A macrocell can overlay portions of multiple private cells. The macrocell can be associated with multiple private paging group identifiers. Implementations can include, when a mobile station, that is in communication with a closed service group femtocell to which the mobile station has access privileges, enters idle mode, assigning the mobile station to a closed service group associated with the closed service group femtocell; and storing a base station identifier associated with the closed service group femtocell to subsequently page the mobile station.

These and other implementations can include paging a mobile station in one or more macrocells belonging to a closed service paging group associated with the mobile station.

These and other implementations can include paging a mobile station in a private cell that is associated with a last registration of the mobile station. Implementations can include when a mobile station, that is in communication with the macrocell, enters an idle mode, assigning the mobile station to a public paging group. Implementations can include when a mobile station, that is in communication with an open service group femtocell, enters an idle mode, assigning the mobile station to a public paging group.

These and other implementations can include operating a paging control function to page a mobile station based on information that associates the mobile station with one or more private cells. Implementations can include using a multi-level paging procedure which attempts paging first to one or more private cells and an associated overlying macrocell belonging to the same closed service paging group that is assigned to a mobile station during an idle mode entry or during a last successful location update procedure; and when no response is detected in response to paging the mobile station via the closed service paging group, paging the mobile station via one or more public paging groups.

These and other implementations can include controlling a mobile station to perform a location update, the location update identifying a specific private cell; causing the location update to proceed if the mobile station has access privilege with the specific private cell identified in the location update process; when the mobile station does have access privilege with the private cell identified in the location update, associating an active paging group of the mobile station with the private cell; and when the mobile station does not have access privilege with the private cell identified in the location update, redirecting the mobile station to a public access cell. Redirecting the mobile station to a public access cell can include redirecting the mobile station based on a load balancing policy.

These and other implementations can include maintaining information of which private cells a wireless device has access; paging a wireless device in a subset of those private cells to which the wireless device has access. Implementations can include operating a mobile station to scan for one or more private cells based on provisioning information, wherein the provision information can include one or more preamble indices together with one or more corresponding cell identifiers and respective corresponding geographical location of the target cells. Implementations can include operating a mobile station to store identities of one or more private cells to which the mobile station has been granted closed service group access to facilitate searching for a private cell.

In another aspect, techniques for wireless communication can include operating a macrocell using a public paging identity and a closed group paging identity, wherein the closed group paging identity is shared by multiple private cells; assigning the closed group paging identity to a mobile station, where the mobile station is in communication with a base station associated with one of the private cells; storing an identity of the base station serving the mobile station; and paging the mobile station using the closed group paging identity and the stored identity of the base station. Other implementations can include corresponding systems, apparatus, and computer programs, configured to perform the actions of the techniques, encoded on computer readable mediums.

In yet another aspect, wireless communication systems can include a femtocell base station configured to provide wireless service to wireless devices in at least a portion of a macrocell; and a core network in communication with the femtocell base station. The core network can include means for providing wireless service to mobile stations in the macrocell, the macrocell associated with a public paging group identifier and a private paging group identifier; means for assigning the private paging group identifier to one or more private cells that are spatially situated in at least a portion of the macrocell, the one or more private cells are operable by one or more base stations to restrict wireless access to specific wireless devices; and means for using wireless device access privileges associated with the one or more private cells for one or more wireless operations associated with the mobile stations, the wireless operations including paging and location update.

In yet another aspect, apparatuses and systems for wireless communications can include transceiver electronics to communicate with wireless devices in a coverage area; and processor electronics, in communication with the transceiver electronics, configured to perform operations described herein.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an example of a wireless communication system.

FIG. 2 shows an example of a radio station architecture.

FIG. 3 shows a different example of a wireless communication system.

FIG. 4 shows an example of a geographical layout and paging group assignments to private cells and overlying macrocells.

FIG. 5 shows an example of a technique for wireless communications.

Like reference symbols in the various drawings indicate like elements.

### DETAILED DESCRIPTION

Private wireless networks can provide wireless service in areas such as homes, offices, and corporate or university campuses. Private wireless networks can communicate with wireless devices in one or more private cells. Such networks can provide wireless services in conjunction with public wireless networks, which can provide wireless services to the general public. A combination of public and private networks can be used to provide a higher quality mobility environment for wireless users within areas in which the user wishes to maintain communications while on the move or at different locations.

The addition of many small home-area and office-area wireless cells, such as femtocells, into the traditional macrocellular network introduces some new challenges to the traditional way of designing paging groups. In some cases, the numbers of femtocells are more numerous than the numbers of macrocells. In some cases, a wireless device can reside within the coverage of one of these cells for an extended period of time rather than be moving between cells. A user with a wireless device, for example, arrives at his home equipped with a femtocell, his wireless device can remain in communication with the femtocell for the remainder of the day and the night before leaving home.

A femtocell base station can transmit and receive wireless signals in one or more cells such as public or private cells. Access to a private cell can be restricted to a small subset of the users of an associated macrocellular public wireless network. Various examples of private cells can include private home-area cells and private office-area cells. In some implementations, private cells such as Closed Service Group (CSG) femtocells are restricted to a small subset of one or more user of a macrocellular network. In some implementations, a femtocell can be open to serve any user from the macrocellular network in which case it is referred to as an Open Service Group (OSG) femtocell.

A wireless device, when not active in a communications session, can power down one or more portions of the device's circuitry to extend the charge of the device's battery. During a power down, a wireless device can maintain minimal functionality to maintain the device's presence in the wireless network and to be prepared in case a call or data arrives for the device from the wireless network. A wireless device in such an operating condition is said to be in an idle, or dormant, state or mode. A wireless network can notify a wireless device of an incoming call or data for the device by using a paging technique.

A paging technique can provide a balance between how precisely to track the location of the mobile terminal, or mobile station in an idle mode and how large a number of cells of the wireless network need to be paged in order to ensure that the MS receives the notification. The cells of a wireless network can be divided up into possibly overlapping paging groups, or areas, and the MS is tracked by the network to be located within the cells of one of these paging groups. When the MS needs to be notified of an incoming call or data, the MS can be notified via a paging notification which is sent to cells within the paging group that the MS was last known to be in.

The term “cell” can be used to denote a radio coverage area that would require a handover to maintain communications continuity as the mobile station moves into the radio coverage area. This can map to either an omni-cell or the sectors of a sectorized cell. The term “user” can be used to denote the subscriber and may be extended to also include the corresponding device(s) used by the subscriber to connect to a private cell or to a macrocell. The term “MS” can refer to a wireless device that belongs to a subscriber. The term macrocellular network can denote the collection of cells and associated network data transfer, control and administrative functions of the wireless access network through which all users who have subscribed for access service from the macrocellular operator have privileges to access. The term macrocell can denote a cell that is part of a macrocellular network with the usage of the term is in relation to the global access privileges for all subscribers at these cells and not in relation to the size of the coverage area of the cell.

Some techniques of assigning cells to paging groups may be ineffective or inefficient for some wireless communication systems with private cells. For example, a method for assigning cells to paging groups can include an assignment of adjacent cells to a paging group. Such a method may work well for a macrocellular network because a MS can be expected to be moving and so will generally be traversing adjacent cells. However, private cells can be scattered in a geographical region and different private cells can have different sets of authorized users. Grouping private cells that are in the general vicinity of each other into a paging group may not effective since paging a user in a cell where it is certain the user cannot be reached is a waste of both backhaul and over-the-air resources. A similar drawback may occur if private cells are grouped in a paging group with a large number of macrocells in the same vicinity. Over-the-air and backhaul resources of the macrocells to be paged may be used inefficiently there if the user is currently located in a private cell since the user is typically expected to stay within the coverage area of the private cell for an extended period of time.

In a different example of a method that may be ineffective or inefficient in some wireless communication systems with private cells, a method for assigning cells to paging groups can include the option to assign any cell with another other cell to a paging group. Such a method may work for a macrocellular network since a macrocell provides access to the full set of subscribers to the network. However, since a private cell can admit a small subset of users of a macrocellular network, including a private cell with macrocells in the same paging group used for general users of the macrocellular may be inefficient for the private cell since it will receive pages for many users that cannot be reached via the private cell. Similarly, including private cells in the same paging group with other private cells may be inefficient since they generally support different users and so the cells will receive pages for users that cannot be reached through that cell.

In yet a different example of a method that may be ineffective or inefficient in some wireless communication systems with private cells, a method for assigning cells to paging groups can include the use of preamble alone to differentiate between the non-accessible private cell and the macrocell, and to identify the appropriate private cell or the macrocell for the MS to perform the location update (LU) or to respond to paging. This approach may not feasible because of a limited number of “fixed” preambles. The mapping between the Cell ID and the Preamble Index can be replicated across different geographical locations, not to mention the additional complexity to plan in advance and to coordinate the assignment of those preambles between the private cells and the macrocells.

This document include descriptions of technologies, among other things, for wireless communication systems that include private cells. For example, this document includes techniques for assigning paging groups in wireless communication systems that include one or more private cells. Wireless communication systems operations can include assigning private cells to paging groups, associating users to private cells and their assigned paging groups, paging a user last known to being served by a private cell, and control wireless devices to perform a location update, to respond to paging, and to exit from an idle mode.

Systems and techniques for wireless communication systems that include private cells can include a paging mechanism to support the presence of users within private cells in a wireless network based on an organization of private cells into paging groups, a procedure of paging users currently served by private cells, and a procedure of handling the MS to perform the location update (LU), to respond to the paging with the private cell or with the macrocell, and to exit from Idle mode with the private cell or with the macrocell. The technologies described in this document can be applied to different cell types, e.g., picocells, microcells, OSG-femtocell, in a hierarchical cellular network arrangement.

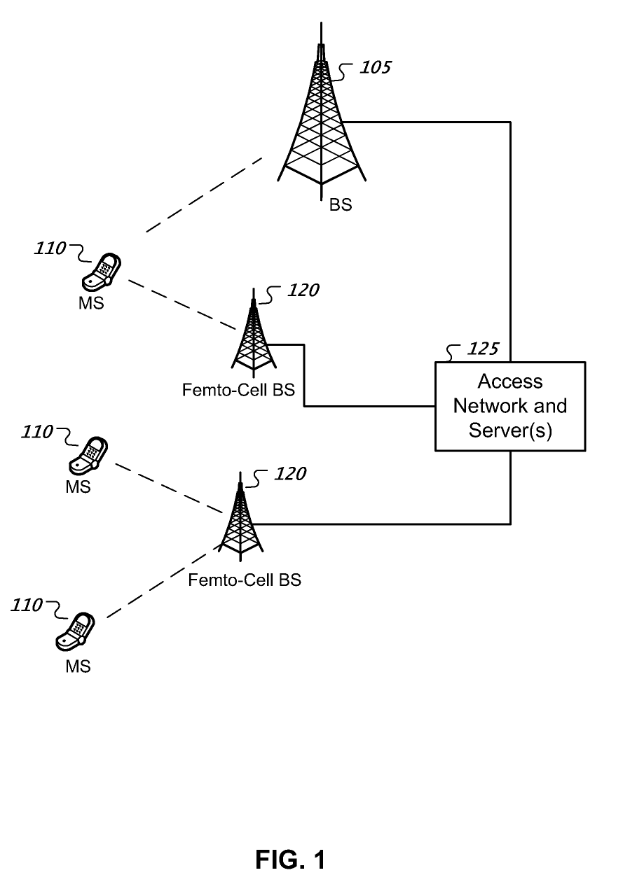

FIG. 1 shows an example of a wireless communication system. The techniques described herein can be implemented in a system such as the one shown in FIG. 1. A wireless communication system can include one or more base stations (BSs) 105 and one or more wireless devices 110. A base station 105 can transmit a signal on a forward link (FL), called a downlink (DL) signal, to one or more wireless devices 110. A wireless device 110 can transmit a signal on a reverse link (RL), called an uplink (UL) signal, to one or more base stations 105. A wireless communication system can include access network and server components 125. A wireless communication system can include femto-cell access points (FAP) such as one or more femto-cell base stations 120 that can provide wireless service to one or more wireless devices 110.

Base stations 105, femto-cell base stations 120, and wireless devices 110 can communicate with each other using wireless technology such as Long-Term Evolution (LTE), Code division Multiple Access (CDMA) such as CDMA2000 1x, High Rate Packet Data (HRPD), Universal Mobile Telecommunications System (UMTS), and Worldwide Interoperability for Microwave Access (WiMAX).

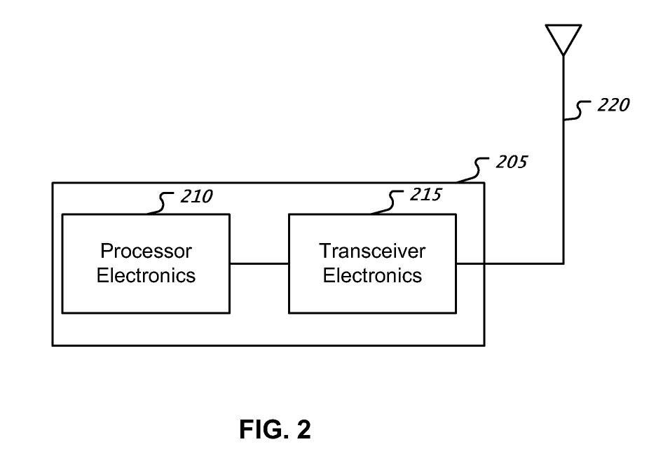

FIG. 2 shows an example of a radio station architecture. A radio station 205 such as a base station or a wireless device can include processor electronics 210 such as a microprocessor that implements methods such as one or more of the techniques presented in this document. A radio station 205 can include transceiver electronics 215 to send and/or receive wireless signals over one or more communication interfaces such as an antenna 220. A radio station 205 can include other communication interfaces for transmitting and receiving data. A radio station 205 can include one or more memories configured to store information such as data and/or instructions.

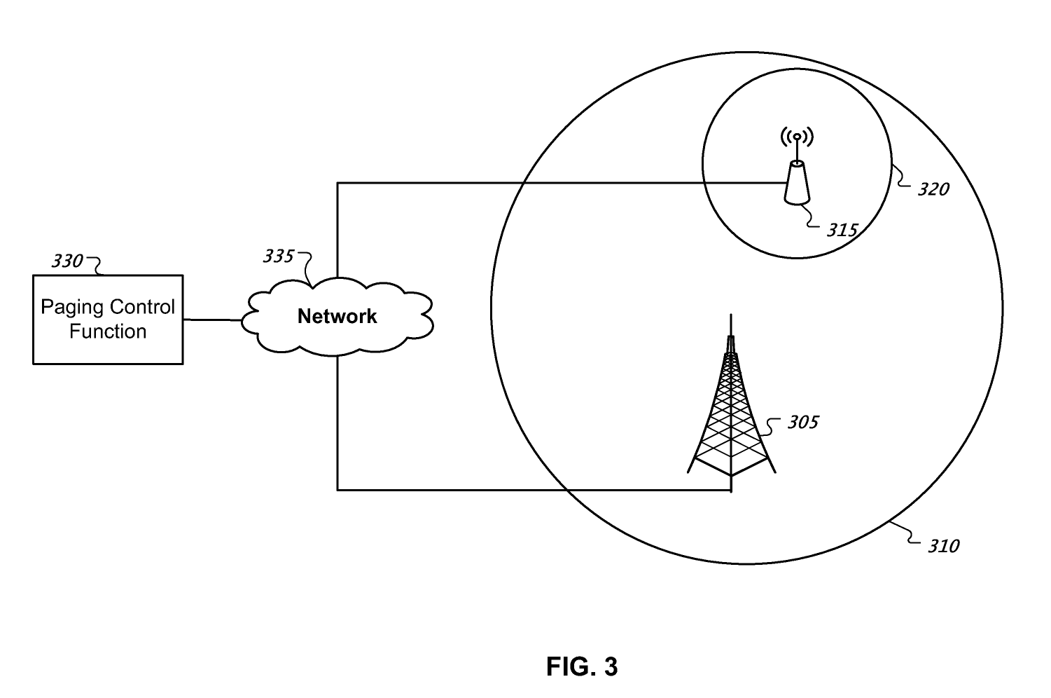

FIG. 3 shows a different example of a wireless communication system. A wireless communication system can include a macrocellular network that includes one or more base stations 305 associated with one or more macrocells 310. A wireless communication system can include one or more base stations 315 associated with one or more private cells 320.

Assignment of paging groups can be coordinated between private cells and the macrocellular part of the wireless network. A wireless communication system can include a network 335 to connection base stations 305, 315 and different servers such as a server configured to operate a Paging Control Function (PCF) 330. Some wireless networks can share a PCF 330 between a macrocellular network and one or more private cells. A PCF 330 can store assignments of paging groups to users and cells. A PCF 330 can generate a paging notification for a wireless device.

The private cell is private in the sense that access for service may be limited to a small subset of the users of a wireless communication system. If access is so limited, control of which users can be allowed access is administered separately from the subscription for access to the macrocellular network. A base station can perform access control in the private cell using an Access Control List (ACL). An ACL can specify a privilege for a wireless device to access a private cell. In some implementations, an ACL can include an identifier such as a Medium Access Control (MAC) address of a wireless device to specify an access privilege for the wireless device. A wireless device can send a MAC address in a protocol message. Access control techniques can include authentication and authorization of both wireless device and user.

An administrative relationship between the private cell and macrocellular network can be based on one or more business arrangements and can be based on one or more trust relationships. In some cases, a wireless operator may operate both a private cell and the macrocellular network. For example, users with subscriptions to the macrocellular network for wireless access may have access privilege to the private cell, however, the users may not be serviced by a different private cell(s) (e.g., moving out of the coverage area of the private cell) because the users may not have access privileges.

A trust relationship can exist between the administrative entity of the private cell and the operator of the macrocellular network. The trust relationship can be such that any addition of users granted access to the private cell is communicated to the administrative system of the macrocellular network, with the user being identified by an identifier that can be associated by the macrocellular network to an authenticated user and device.

private cells can be segregated into one or more paging groups that are separate from the paging groups assigned to public users of the macrocellular network. This prevents many extraneous paging notifications from consuming backhaul and over-the-air resources at the private cells. In some case, more than one private cell serving different sets of users can be assigned into one paging group without incurring extraneous paging overhead due to the redefinition by this solution of the paging behavior by the system for paging groups containing private cells. Specifically, paging within a paging group containing private cells, which is referred to as a CSG paging group, does not follow the general rule of sending paging notifications to all cells within the paging group. Instead, the system maintains on a per-user basis to which private cells a user has been granted access and paging for those users for the CSG paging group occurs only in those private cells for which the user has been granted access.

To allow the MS to be easier to isolate the private cell that the MS has the access privilege to, one or more preamble indices together with the corresponding cell-ids and the corresponding geographical location of the target cells can be pre-provisioned to the MS, such pre-provisioning parameters will then assist the MS to perform an intelligent scanning to select the appropriate private cell for cases such as a LU, paging response, or an exit from idle mode.

A MS can obtain cell information to perform an intelligent scan of radio signals to select a private cell to proceed with a LU, respond to a page, or to exit from idle mode. Cell information can include a set of one or more preamble indices together with the corresponding cell-ids and the corresponding geographical location of the target cells. In some implementations, a MS can come pre-provisioned with cell information. Over the Air (OTA) provisioning can update cell information or store cell information on the MS. In some implementations, manual provisioning can include loading cell information in to a MS.

Wireless networks can assign a private cell to a paging group. In some implementations, private cells are assigned to separate paging groups from those assigned to serve public users of macrocells, which can include OSG-femtocells. Using separate paging groups for private calls can reduce the amount of extraneous paging in private cells since private cells can serve a very small subset of users of the macrocellular network. A wireless network that supports private cells can reserve a set or subset of paging groups to assign to groups of private cells, such as CSG Paging Groups. An overlying macrocell(s) with a coverage area that includes or is in proximity to that of the femtocell(s) of a CSG Paging Group can be assigned to the same CSG Paging Group. This can prevent extraneous location updates (LU) of a CSG user between the private cell and an overlying macrocell if the user is near the coverage area of the private cell. In some implementations, private cells are divided into different paging groups according to geographic proximity

In some implementations, each private cell can be defined as a paging group on its own since a user is expected normally to stay within the coverage area of the private cell for extended periods of time and when moving may migrate directly between the private cell and the macrocellular network. However, this approach may not be feasible or desirable, because a large number of private cells that may exist in a wireless network, which can result in too many paging groups being required.

A paging localization technique can be employed with private cells such that efficient paging can take place even if all private cells within the wireless network are grouped into a single paging group. A paging localization technique can provide the ability to group subsets of the private cells into separate paging groups. This segregation is done via geographic proximity with some reasonable geographic boundary defined for the paging group. One example of such a geographic boundary may be around a neighborhood or adjoining neighborhoods with sizeable open space around the perimeter such that it is very unlikely for a user to move from one private cell to another without first re-registering its presence back to the macrocellular network while in transit. Another example may be based on the coverage area of the overlying macrocell or neighborhood cluster of macrocells.

To support this geographic-based Private-Cell paging group assignment, the geographic location of the private cell is presumed to be known by the wireless network. One example for implementing this is for the private cell to provide its geographic location to the wireless network when the private cell first makes itself known to the wireless network.

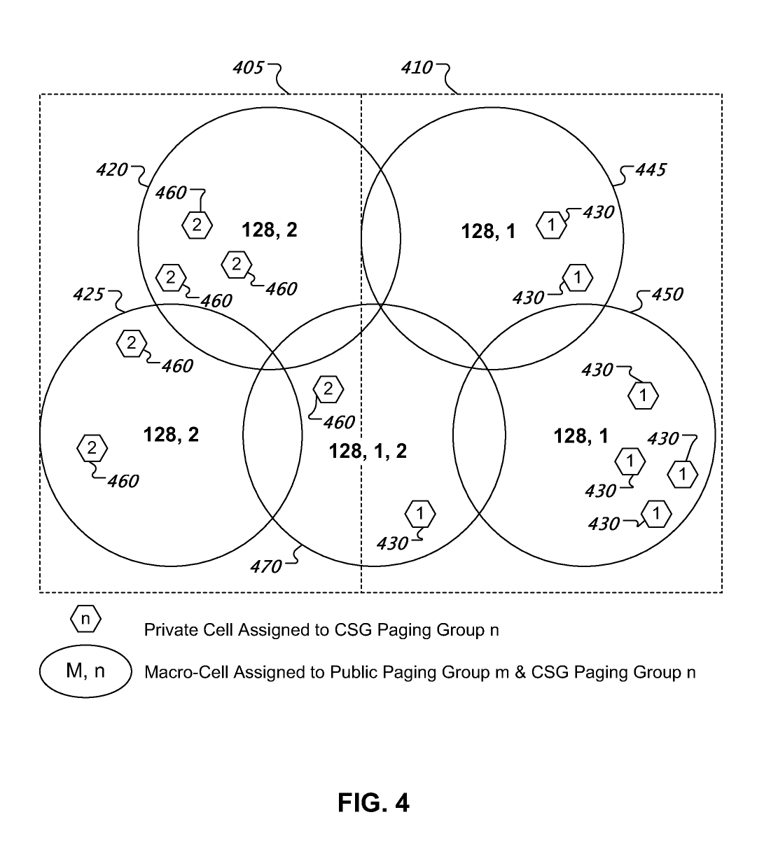

FIG. 4 shows an example of a geographical layout and paging group assignments to private cells and overlying macrocells. A wireless communication system can include private cells such as private cells 430, 460 assigned to different closed service paging groups. A wireless communication system can include an assignment area for CSG Paging Group one 410 and an assignment area for CSG Paging Group two 405. A wireless communication system can include different macrocells 420, 425, 445, 450, 470 that overlay the private cells 430, 460. As shown in FIG. 4, overlying macrocells can be assigned to CSG Paging Groups which are assigned different Paging Group Identifiers (1 and 2) from the Public Paging Group with Paging Group ID 128 assigned to the macrocells only. As shown in FIG. 4, two different CSG Paging Groups can be assigned on the basis of geographic areas as delineated by the dashed rectangular boxes that indicate the assignments 405, 410. A macrocell can belong to more than one CSG Paging Group, e.g., macrocell 470.

In order to minimize the number of Paging Group IDs that need to be reserved for CSG Paging Groups, the same Paging Group ID may be assigned to more than one CSG Paging Group as long as the same Paging Group ID is not used for two different CSG Paging Groups to which one macrocell or adjacent macrocells belong. This restriction in Paging Group ID assignment for CSG Paging Groups is required to ensure that the MS performs an appropriate Location Update (LU) due to Paging Group update as the MS moves to a neighboring macrocell that serves a different CSG Paging Group. When a private cell first makes itself known to the wireless network, it can be assigned to an appropriate CSG Paging Group. CSG Paging Group information can be maintained as operational data by the wireless network.

A private cell can provide wireless service to authorized users. In some implementations, a base station for a private cell can use a method to provision access privileges for new users and devices. Such can method can include using an Access Control List (ACL) and including MAC addresses of wireless devices who are authorized for wireless service on the private cell. In some implementations, a provisioning method can include entering secure private information associated with each authorized user of a private cell an Administration, Authentication and Authorization (AAA) database. Provisioning methods can be compatible with a secure authentication and authorization protocol supported by a wireless technology.

A wireless communication system can distribute provisioning information based on a trust relationship between an administrative entity of a private cell and a wireless network. For example, when a user is granted access to the private cell by being provisioned with access privileges, provisioning information that associates permission for access to the private Cell, as identified by an agreed-to cell identifier, by a specific user, as identified by an agreed-to user identifier (which may be the identifier of a device associated with the user), is made known to the wireless network.

Provisioning information can be exchanged within a wireless communication system. This information exchange can occur via various means In some wireless communication systems, the exchange can include inter-person communications. In some wireless communication systems, this exchange can occur autonomously via a signaling protocol between the private cell and the macrocellular network. A wireless communication system can have up-to-date knowledge of the current list of wireless devices that are authorized access to a specific private cell. A wireless communication system can maintain a list of one or more private cells that a specific wireless device has been granted access to and to which CSG Paging Group each of these private cells belong.

In some implementations, any new such private cell entries are incorporated into the user's wireless network's subscriber operational information. This type of information is maintained as part of a subscriber profile information maintained at a Home AAA (H-AAA) function, distributed across the private cells or located at a centralized gateway function from where the full set of private cell information (along with other necessary configuration and operational information associated with the user) come into effect each time the user is successfully authenticated for service in one or more private cells, such information can include configuration and operation information associated with a user of a wireless device.

In some wireless communication systems, a wireless device user can be associated with a list of private cells to which the user has been granted access. If this list is empty, the user has no private cells in which the user has explicitly been granted access. If the list is non-empty, then the user has a list of entries containing information in each entry in its operational data. An entry in such a list can include a private cell identifier and a paging group identifier. A private cell identifier can identify a private cell and a paging group identifier can identify a CSG Paging Group to which the private cell has been assigned.

A wireless network can acquire knowledge of the privates cells that are associated with the wireless network. The wireless network can assign each private cell to one of the paging groups reserved by the network for use with private cells only. The wireless network has also acquired knowledge of the private cells to which a user has been given access privileges and has kept this data as part of the context information for the user. There are different scenarios by which a wireless device MS is assigned to a CSG Paging Group that corresponds to a private cell and an overlying macrocell(s). For example, a MS enters to an Idle Mode after the MS has already been authorized for and is being served by the private cell. In such a scenario, the network can assign the MS to the CSG Paging Group that corresponds to the private cell as the MS enters Idle Mode operation. Subsequently, the incoming bearer path, of which the destination routing target is the MS, is associated with this specific CSG Paging Group.

In a different example, a MS is in an Idle Mode when the MS arrives to the cell coverage of the private cell. In such a scenario, a MS is in an idle state and moves from a macrocell to a private cell. In some cases, a user's MS is in an idle state and is currently being served by a macrocell. The user and MS move to within the coverage area of a private cell to which the user has been given access privileges and the MS's cell selection algorithm determines that the private cell should become the serving cell. The user's MS can process system parameters being broadcast by the target private cell and can determine whether the paging group that the MS was assigned in the previous cell is no longer available in this cell. If the paging group is not available, the MS can perform a location update to the network and can indicate the need for a change of paging groups. The private cell, recognizing that the user or MS, has permission to access this private cell, can allow the location update to proceed. Otherwise, the private cell can refuse the location update attempt by the user's MS. Recognizing that this new target cell is a private cell, the network provides the ID of the CSG paging group to which this private cell has been assigned to the MS to be used as its new active paging group (e.g. this can be done as part of the acknowledgement to complete the location update signaling procedure to the MS). Subsequently, the incoming bearer path, of which the destination routing target is the MS, is associated with this specific CSG paging group. The user's MS is in an idle state and from the network's perspective, the MS's last known location is the private cell through which it experienced a change of paging groups.

The network can receive an incoming call or data for a wireless device. As the incoming bearer path for the user's MS has been associated with a CSG paging group, the Paging Control Function in the network can retrieve the list of private cells within this paging group to which the user has access privileges and the identifier of the private cell through which the MS has performed its last location update from the operational data maintained with respect to the user and/or the user's MS. The Paging Control Function can generate a page to the private cell(s) which allows the MS's access and the overlying macrocell(s) belonging to the CSG Paging Group associated with the private cell that the MS last performed a location update.

On successfully receiving a response to the page (e.g., via the initiation of exit from idle state procedure by the user's MS), the network can perform one or more procedures to activate the MS from idle state. On failure, the Paging Control Function retries a configurable number of retries within this same set of private cells and overlying macrocells in this CSG Paging Group before attempting paging on a wider scope, such as to the Public Paging Group(s) that covers the same and neighboring geographic areas of this CSG paging group and which has also have been assigned to the MS. On successfully receiving a response to the page (e.g., via the initiation of exit from idle state procedure by the user's MS), the network can perform one or more procedures to activate the MS from idle state. On failure of paging to the macrocellular network, the paging procedure is deemed to have failed and the MS may be considered dis-engaged from the wireless network (e.g., by being powered off).

When the MS is going to perform a LU, to respond to paging or to exit from idle mode, if there is no nearby private cell that the MS has the access privilege, the MS can select a macrocell. If the MS selects a target private cell (e.g. via the airlink message Ranging Request—RNG-REQ) that the MS has no access privilege, the target private cell shall redirect the MS to one or more overlying or nearby macrocells by including the list of preamble indices of the macrocells (e.g. via the airlink message Ranging Response—RNQ_RSP). By performing the redirection from the non-accessible target private cell to the accessible macrocell, the MS can proceed with the desired operation as soon as possible while minimizing the airlink overhead to trial for another target cell which may also fail. In addition, the redirection can allow the possibility to apply the load balancing to distribute the MSs across multiple macrocells.

To enable the target private cell to support such re-direction, each private cell shall be pre-configured or auto-discovered or auto-configured with a list of neighbor macrocells parameter, e.g., Preamble Index Override as specified IEEE 802.16 specification. This parameter specifies the Preamble Indices of new target BS(s) where the MS should redo ranging. If this parameter includes two or more Preamble Indices, the first one in the list is the most preferable and the second is the next preferable. When the parameter is used with Downlink frequency override parameter, the MS should redo ranging on the new Downlink (DL) channel identified by the Preamble Indices.

Once the MS is connected to the macrocell or to a private cell that the MS has the access privilege, the existing procedures for the MS to proceed with the LU, the paging response and the idle mode exit shall be applied.

In the case when the MS exits the idle mode which is due to the emergency call (e.g. E911), it is the network policy and the regional regulation to determine if the private cell that the MS has no access privilege still be obligated to accept the MS's access request (e.g. RNG_REQ).

Once the MS exits from the Idle Mode due to responding to the paging response or self-initiated Idle Mode Exit, and if the MS is within the neighborhood of the private cell that the MS has the access privilege, dependent on the network policy, it might be more preferable for the MS to be served by the private cell. As the result, the network may initiate the handover procedures to the new target private cell. However, the network shall prevent the ping-pong effect when such action is taken.

To support such network initiated handover procedures, the network can access a list of the private cells that a MS has the access privilege which shall be part of the MS's context information. This handover operation can be implemented in various configurations.

This document includes descriptions of methods, apparatuses, and systems to support paging idle operation for Mobile Station devices in a wireless network that includes private cells such as CSG-femtocells. Implementations can include one or more of the following features.

A pre-provisioned set of the preamble indices together with the corresponding cell-ids and the corresponding geographical location of the target cells to the MS in order to enable a more efficient scanning to the target cells that the MS has the access privilege.

A paging group organization that segregates private cells into one or more paging groups that contain private cells and their overlying macrocells only.

Pre-allocate a group of Paging Group IDs (PGIDs) that are used for paging groups that include a set of private cells such as CSG-femtocells and their overlying macrocells. These paging groups are referred to as CSG Paging Groups.

Pre-allocate a group of PGIDs that are assigned to paging groups that include only those cells that serve all users allowed access to the wireless network in general; these cells include macrocells, microcells, picocells and OSG-femtocells. These paging groups are referred to as Public Paging Groups.

A femtocell can operate as a closed service group and an open user group. For example, such a femtocell can belong to both a CSG Paging Group and Public Paging Group at the same time.

A macrocell can belong to one or more CSG Paging Groups along. The macrocell can belong to one or more Public Paging Groups if the macrocell overlays one or more sets of private cells.

If a MS enters Idle mode via a CSG-femtocell to which it has CSG membership, the MS can be assigned to the CSG Paging Group associated with the CSG-femtocell. A Paging Control Function can store a Base Station ID (BSID) of the serving CSG-femtocell. In some implementations, a Paging Controller/Location Register (PC/LR) can include a Paging Control Function.

If a MS enters Idle mode via the macrocell or OSG-femtocell, the MS can be assigned to the Public Paging Group, and no additional specific information need to be updated to the Paging Control Function (e.g. at the PC/LR).

With an MS in Idle Mode that last registered at a CSG-femtocell and assigned to a CSG Paging Group, the Paging Control Function (e.g. at the PC) can recognize that the MS was assigned to the CSG Paging Group. When paging is required to the MS, the Paging Control Function can page the macrocells associated with the same CSG Paging Group. The Paging Control Function can page the specific CSG-femtocell that the MS was last registered (or page all CSG-femtocells to which the MS has access privileges in the specific CSG Paging Group) but does not page additional CSG-femtocells (or other CSG-femtocells to which the MS does not have access privileges) in the specific CSG Paging Group. In this way, the MS may not need to perform Location Update (LU) due to Paging Group change until the MS has moved out of the macrocell paging area of the CSG Paging Group.

An MS in Idle Mode that has been assigned to a Public Paging Group is paged via all of the OSG-femtocells and macrocells belonging to that Public Paging Group.

Wireless techniques can include a paging procedure for users being served by private cells where all private cells in the a geographic area or within the coverage area of a neighborhood cluster of macrocells (which may be as small as the coverage area of one macrocell) can be in one paging group. The wireless network can obtain and can maintain up-to-date knowledge as to which users have been explicitly granted access to which private cells. A Paging Control Function of the wireless network uses the knowledge of user access privileges of a given set of private cells, that are belonged to the paging group which has been assigned to the user, in order to generate pages to this set of private cells and their overlying macrocells that belong to the same CSG Paging Group to page the user.

Wireless techniques can include a method of grouping private cells into more than one paging group, if available, via the use of geographic information on the location of the private cell, and defining a geographic boundary for a paging group where such geographic boundary may be defined by the coverage area of a neighborhood cluster of one or more macrocells.

Wireless techniques can include a multi-level paging procedure which attempts paging first to one or more private cells and the overlying macrocell(s) belonging to the same CSG Paging Group that is assigned to the user during the most recent Idle Mode Entry or during the last successful location update procedure. If no response is received from paging the user via the CSG Paging Group, attempt may be made to page the user via the Public Paging Group(s) of the macrocells that includes the macrocells belonging to the CSG Paging Group and to which the MS may also have been assigned.

A location update process can include a location update signaling procedure. In some implementations, a location update signaling procedure is allowed to complete successfully on a private cell if the user has been granted access privileges to the private cell. If the user has not been granted access privileges to the private cell, the user's location update request can be refused.

A private cell, identified as a target private cell, can support re-direction of the MS from itself (i.e. non-accessible target Private cell) to the accessible Macro cell. Each private cell shall be pre-configured or auto-discovered or auto-configured with a list of neighbor macrocells parameter that the MS can then be easily be re-directed to. By performing the redirection from the non-accessible target private cell to the accessible macrocell, the MS can proceed with the desired operation as soon as possible while minimizing the airlink overhead to trial for another target cell which may also fail. Wireless communication systems can use the redirection to perform load balancing to distribute the MSs across multiple macrocells.

Once the MS exits from the Idle Mode due to responding to the paging response or self-initiated, and if the MS is within the neighborhood of the private cell that the MS has the access privilege, dependent on the network policy, it might be more preferable for the MS to be served by the private cell. As the result, the network may initiate the handover procedures to the new target private cell to off-load the macro cell. The network can prevent the ping-pong HO effect as the result of such decision.

To support such network initiated handover procedures, the network can receive the list of the private cells that MS has the access privilege which can be part of the MS's context information.

In some case, a user can operate different wireless devices. In some implementations, access privileges for a private cell can be based on an identifier of a user. In some implementations, private cell access privileges can be based on an identifier of a wireless device. In some implementations, private cell access privileges can be based on a user identifier and a wireless device identifier such as a MAC.

In some implementations, a method for providing communications to a mobile station subscribed to a wireless communication network and having access privilege to one or more private cells, can include dividing private cells into paging groups; operating the wireless communication network to acquire cell locations and cell identification codes of private cells; and operating the communication network to provide paging signaling between a mobile station and the paging groups based on cell locations and cell identification codes of private cells in the paging groups to provide efficient paging.

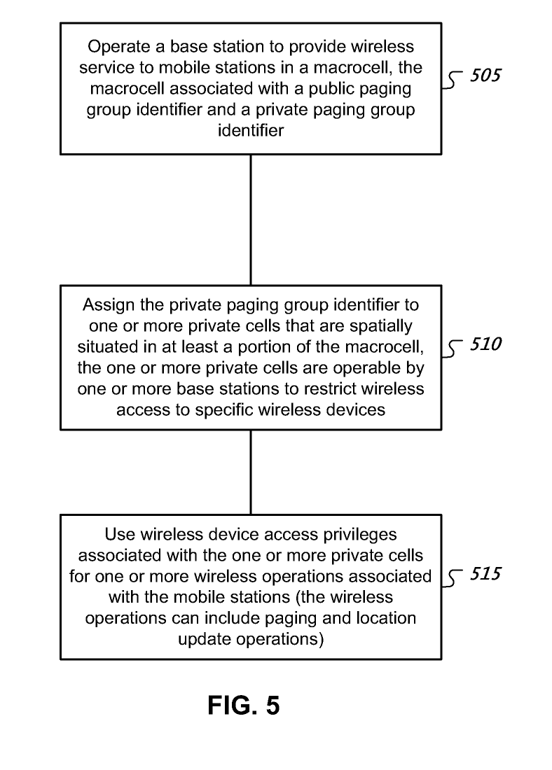

FIG. 5 shows an example of a technique for wireless communication. A technique for wireless communications can include operating a base station to provide wireless service to mobile stations in a macrocell, the macrocell associated with a public paging group identifier and a private paging group identifier (505); assigning the private paging group identifier to one or more private cells that are spatially situated in at least a portion of the macrocell, the one or more private cells are operable by one or more base stations to restrict wireless access to specific wireless devices (510); and using wireless device access privileges associated with the one or more private cells for one or more wireless operations associated with the mobile stations, the wireless operations including paging and location update (515).

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations may be made based on what is disclosed.

What is claimed is:

1. A method for wireless communications, comprising:
operating a base station to provide wireless service to mobile stations in a macrocell, the macrocell associated with a public paging group identifier and a private paging group identifier;
assigning the private paging group identifier to one or more private cells that are spatially situated in at least a portion of the macrocell, the one or more private cells are operable by one or more base stations to restrict wireless access to specific wireless devices; and
using wireless device access privileges associated with the one or more private cells for one or more wireless operations associated with the mobile stations, the wireless operations including paging and location update.

2. The method of claim 1, further comprising:
accessing information associated the one or more private cells, the information indicative of a private cell access privilege of a wireless device.

3. The method of claim 2, wherein accessing information associated the one or more private cells comprises accessing a private cell identifier associated with the private cell access privilege and paging group identifier associated with the private cell identifier.

4. The method of claim 1, wherein assigning the private paging group identifier to one or more private cells comprises assigning a single paging group identifier to multiple private cells based on a geographic proximity of the multiple private cells by an overlap of each of the multiple private cells coverage areas within a coverage area the macrocell or a set of adjacent macrocells.

5. The method of claim 1, further comprising:
using a pre-allocated group of paging group identifiers to assign a private paging group to multiple private cells and one or more associated overlying macrocells; and
using a pre-allocated group of paging group identifiers to assign a public paging group to a wireless cell operable for public wireless access.

6. The method of claim 1, further comprising:
assigning a femtocell associated with a femto base station to a closed service group and to an open user group.

7. The method of claim 1, wherein the macrocell overlays portions of multiple private cells, wherein the macrocell is associated with multiple private paging group identifiers.

8. The method of claim 1, further comprising:
when a mobile station, that is in communication with a closed service group femtocell to which the mobile station has access privileges, enters idle mode, assigning the mobile station to a closed service group associated with the closed service group femtocell; and
storing a base station identifier associated with the closed service group femtocell to subsequently page the mobile station.

9. The method of claim 1, further comprising:
paging a mobile station in one or more macrocells belonging to a closed service paging group associated with the mobile station.

10. The method of claim 1, further comprising:
paging a mobile station in a private cell that is associated with a last registration of the mobile station.

11. The method of claim 1, further comprising:
when a mobile station, that is in communication with the macrocell, enters an idle mode, assigning the mobile station to a public paging group.

12. The method of claim 1, further comprising:
when a mobile station, that is in communication with an open service group femtocell, enters an idle mode, assigning the mobile station to a public paging group.

13. The method of claim 1, further comprising:
operating a paging control function to page a mobile station based on information that associates the mobile station with one or more private cells.

14. The method of claim 1, further comprising:
using a multi-level paging procedure which attempts paging first to one or more private cells and an associated overlying macrocell belonging to the same closed service paging group that is assigned to a mobile station during an idle mode entry or during a last successful location update procedure; and
when no response is detected in response to paging the mobile station via the closed service paging group, paging the mobile station via one or more public paging groups.

15. The method of claim 1, further comprising:
controlling a mobile station to perform a location update, the location update identifying a specific private cell;
causing the location update to proceed if the mobile station has access privilege with the specific private cell identified in the location update process;
when the mobile station does have access privilege with the private cell identified in the location update, associating an active paging group of the mobile station with the private cell; and
when the mobile station does not have access privilege with the private cell identified in the location update, redirecting the mobile station to a public access cell.

16. The method of claim 15, wherein redirecting comprises redirecting the mobile station based on a load balancing policy.

17. The method of claim 1, further comprising:
maintaining information of which private cells a wireless device has access;
paging a wireless device in a subset of those private cells to which the wireless device has access.

18. The method of claim 1, further comprising:
operating a mobile station to scan for one or more private cells based on provisioning information, wherein the provision information comprises one or more preamble indices together with one or more corresponding cell identifiers and respective corresponding geographical location of the target cells.

19. The method of claim 1, further comprising:
operating a mobile station to store identities of one or more private cells to which the mobile station has been granted closed service group access to facilitate searching for a private cell.

20. A method for wireless communications, comprising:
operating a macrocell using a public paging identity and a closed group paging identity, wherein the closed group paging identity is shared by multiple private cells;
assigning the closed group paging identity to a mobile station, wherein the mobile station is in communication with a base station associated with one of the private cells;
storing an identity of the base station serving the mobile station; and
paging the mobile station using the closed group paging identity and the stored identity of the base station.

21. The method of claim 20, wherein paging the mobile station comprises:
paging the mobile station using the closed group paging identity via the base station associated with the stored identity; and
selectively paging the mobile station using the closed group paging identity via the macrocell.

22. The method of claim 20, further comprises:
determining a set of private cells to which the mobile station has access,
wherein paging the mobile station comprises paging the mobile station through one or more private cells in the determined set of private cells.

23. The method of claim 20, wherein operating the macrocell comprises operating the macrocells with multiple closed group paging identities.

24. An apparatus for wireless communications, comprising:
transceiver electronics to communicate with wireless devices in a coverage area; and
processor electronics, in communication with the transceiver electronics, configured to perform operations, the operations comprising:
operating a base station to provide wireless service to mobile stations in a macrocell, the macrocell associated with a public paging group identifier and a private paging group identifier;
assigning the private paging group identifier to one or more private cells that are spatially situated in at least a portion of the macrocell, the one or more private cells are operable by one or more base stations to restrict wireless access to specific wireless devices; and
using wireless device access privileges associated with the one or more private cells for one or more wireless operations associated with the mobile stations, the wireless operations including paging and location update.

25. A wireless communication system, comprising:
a femtocell base station configured to provide wireless service to wireless devices in at least a portion of a macrocell; and
a core network in communication with the femtocell base station, comprising:
means for providing wireless service to mobile stations in the macrocell, the macrocell associated with a public paging group identifier and a private paging group identifier;
means for assigning the private paging group identifier to one or more private cells that are spatially situated in at least a portion of the macrocell, the one or more private cells are operable by one or more base stations to restrict wireless access to specific wireless devices; and
means for using wireless device access privileges associated with the one or more private cells for one or more wireless operations associated with the mobile stations, the wireless operations including paging and location update.
